(19) United States
(12) Patent Application Publication
(10) Pub. No.: US 2021/0342024 A1
(43) Pub. Date: Nov. 4, 2021

(54) TOUCH DISPLAY APPARATUS AND METHOD FOR MANUFACTURING SAME

(71) Applicant: WUHAN CHINA STAR OPTOELECTRONICS SEMICONDUCTOR DISPLAY TECHNOLOGY CO., LTD., Wuhan (CN)

(72) Inventors: Xian Li, Wuhan (CN); Jun Chen, Wuhan (CN)

(73) Assignee: WUHAN CHINA STAR OPTOELECTRONICS SEMICONDUCTOR DISPLAY TECHNOLOGY CO., LTD., Wuhan (CN)

(21) Appl. No.: 16/472,407

(22) PCT Filed: Jan. 21, 2019
(86) PCT No.: PCT/CN2019/072475

§ 371 Date: Jun. 21, 2019

(30) Foreign Application Priority Data
Dec. 12, 2018 (CN) 201811519554.7

(51) Int. Cl. G06F 3/041; G02B 5/30

(52) U.S. Cl. CPC G06F 3/041; G06F 2203/04103; G02B 5/3025

(57) ABSTRACT

A touch display apparatus is provided. The touch display apparatus includes a display panel comprising a display area and a non-display area, a touch panel disposed on the display panel, a circuit board element disposed on the touch panel corresponding to the non-display area of the display panel, and a polarizing element including a first polarizing element and a second polarizing element. The first polarizing element is disposed on the touch panel corresponding to the display area and a portion of the non-display area, the second polarizing element is disposed on the circuit board element corresponding to a remaining portion of the non-display area of the display panel. The polarizing element is without clearance between the touch panel and the circuit board element, thereby realizing an ultra-narrow frame display design of the touch display apparatus. A method for manufacturing the touch display apparatus is also provided.

### FIELD OF INVENTION

This disclosure relates to touch display technology, and more particularly, to a touch display apparatus and a method for manufacturing the touch display apparatus.

### BACKGROUND OF INVENTION

In recent years, touch display technology of narrow frame displays has received much attention. First, the narrow frame display can be provided with a higher screen ratio, allowing a mobile terminal comprising a larger display to fit into a smaller body scale. Secondly, the narrow frame display produces great visual effects and can produce a perfect video and gaming experience. With the continuous advancement of technology and research and innovation of technology, ultra-narrow frame display and even frameless display will be a trend of future development.

At present, chip on pi (COP) packaging technology is mainly used for manufacturing the narrow frame display. This technical solution mainly refers to add-on touch film bonding technology. As shown in FIG. 1, in order to narrow a frame, a bonding region for a printed circuit board 2 being attached to a touch panel 1 is limited, and bonding of a polarizing plate 3 and the printed circuit board 2 in the bonding region is very risky. For example, the bonding of the polarizing plate 3 and the printed circuit board 2 may cause air bubbles 5 to enter a display area AA. Therefore, in conventional technology, an opening 4 is formed between the polarizing plate 3 and the printed circuit board 2 to solve the above problem, as shown in FIG. 2A and FIG. 2B. However, this will reduce the bonding region of the printed circuit board 2. If a length of the bonding region of the printed circuit board 2 is very small, there is a risk that the printed circuit board 2 is peeled off from the touch panel 1 or the bending of the printed circuit board 2 causes the touch panel 1 to be broken when the printed circuit board 2 is attached to the touch panel 1.

Therefore, it is necessary to provide a touch display apparatus and a method for manufacturing the touch display apparatus, which solves the problems caused by the bonding of the polarizing plate 3 and the printed circuit board 2 in the conventional technology.

### SUMMARY OF INVENTION

In the conventional technology, the bonding of a polarizing plate and the printed circuit board of the touch panel in the bonding region is very risky. The bonding of the polarizing plate and the printed circuit board may cause air bubbles to enter the display area, and the printed circuit board may be peeled off from the touch panel or the bending of the printed circuit board may cause the touch panel to be broken.

In order to solve the above-mentioned drawbacks, the disclosure provides a touch display apparatus. The touch display apparatus comprises a display panel comprising a display area and a non-display area, a touch panel disposed on the display panel, a circuit board element disposed on the touch panel corresponding to the non-display area of the display panel, and a polarizing element comprising a first polarizing element and a second polarizing element. The first polarizing element is disposed on the touch panel corresponding to the display area and a portion of the non-display area of the display panel. The second polarizing element is disposed on the circuit board element corresponding to a remaining portion of the non-display area of the display panel. The first polarizing element is adjacent to the circuit board element, and the polarizing element is without clearance between the touch panel and the board element.

The first polarizing element is closely adjacent to the circuit board element in a horizontal direction, and the second polarizing element is closely attached to the circuit board element in a vertical direction.

According to an embodiment of the disclosure, the first polarizing element comprises a first edge, the second polarizing element comprises a second edge, the circuit board element comprises a third edge, and the first edge is aligned with the second edge and the third edge.

According to an embodiment of the disclosure, an interface between the first polarizing element and the second polarizing element is aligned with the third edge of the circuit board element.

According to an embodiment of the disclosure, a side portion of the first polarizing element is attached to a side portion of the circuit board element and a partial of a side portion of the second polarizing element.

According to an embodiment of the disclosure, a length direction of the non-display area and a length direction of the second polarizing element are parallel to a length direction of the display panel.

In order to solve the above-mentioned drawbacks, the disclosure further provides a touch display apparatus. The touch display apparatus comprises a display panel comprising a display area and a non-display area, a touch panel disposed on the display panel, a circuit board element disposed on the touch panel corresponding to the non-display area of the display panel, and a polarizing element comprising a first polarizing element and a second polarizing element. The first polarizing element is disposed on the touch panel corresponding to the display area and a portion of the non-display area of the display panel. The second polarizing element is disposed on the circuit board element corresponding to a remaining portion of the non-display area of the display panel. The first polarizing element is adjacent to the circuit board element, and the polarizing element is without clearance between the touch panel and the board element.

According to an embodiment of the disclosure, the first polarizing element comprises a first edge, the second polarizing element comprises a second edge, the circuit board element comprises a third edge, and the first edge is aligned with the second edge and the third edge.

According to an embodiment of the disclosure, an interface between the first polarizing element and the second polarizing element is aligned with the third edge of the circuit board element.

According to an embodiment of the disclosure, a side portion of the first polarizing element is attached to a side portion of the circuit board element and a partial of a side portion of the second polarizing element.

According to an embodiment of the disclosure, a length direction of the non-display area and a length direction of the second polarizing element are parallel to a length direction of the display panel.

In order to solve the above-mentioned drawbacks, the disclosure further provides a method of manufacturing a touch display apparatus. The method comprises the steps of: providing a display panel comprising a display area and a non-display area, providing a touch panel on the display panel, providing a circuit board element on the touch panel corresponding to the non-display area of the display panel, and providing a polarizing element, wherein a portion of the polarizing element is formed on the touch panel corresponding to the display area, and another portion of the polarizing element is formed on the circuit board element corresponding to the non-display area, and cutting the polarizing element corresponding to a side portion of the circuit board element to form a first polarizing element and a second polarizing element. The first polarizing element is disposed on the touch panel corresponding to the a display area of the display panel and a portion of the non-display area, the second polarizing element is disposed on the circuit board element corresponding to a remaining portion of a non-display area of the display panel, and the first polarizing element is adjacent to the circuit board element.

According to an embodiment of the disclosure, the first polarizing element comprises a first edge, the second polarizing element comprises a second edge, the circuit board element comprises a third edge, and the first edge is aligned with the second edge and the third edge.

According to an embodiment of the disclosure, an interface between the first polarizing element and the second polarizing element is aligned with the third edge of the circuit board element.

According to an embodiment of the disclosure, a side portion of the first polarizing element is attached to a side portion of the circuit board element and a partial of a side portion of the second polarizing element.

According to an embodiment of the disclosure, a length direction of the non-display area and a length direction of the second polarizing element are parallel to a length direction of the display panel.

Advantageous effects of the disclosure are as follows. Compared with the convention technology, the disclosure provides a touch display apparatus and a method for manufacturing the touch display apparatus. The polarizing plate is divided into two parts. One portion of the polarizing plate is attached on the touch panel corresponding to the display area of the display panel and a portion of the non-display area of the touch panel, the other portion of the polarizing plate is attached on the bonding area of the printed circuit board (i.e., a printed circuit board bonding area corresponding to a remaining portion of the non-display area on the display panel). One portion of the polarizing plate closely adhered to the touch panel in a horizontal direction and adjacent to the printed circuit board is configured to prevent a gap between the polarizing plate and the printed circuit board when the polarizing plate is bonded to the printed circuit board. The gap may cause bubbles in the gap and cause bubbles to enter into the display area. Moreover, the other portion of the polarizing plate adhered to the printed circuit board in a horizontal direction can enhance the structural strength between the printed circuit board and the touch panel. Thus, the drawbacks of the printed circuit board from being peeled off from the touch panel or the touch panel being broken caused by the bending of the printed circuit board can be prevented, thereby implementing the ultra-narrow frame display design of the touch display device.

### DESCRIPTION OF DRAWINGS

FIG. 1 is a cross-sectional schematic diagram of bonding of a conventional polarizer plate and a touch panel that cause bubbles to enter into a display area.

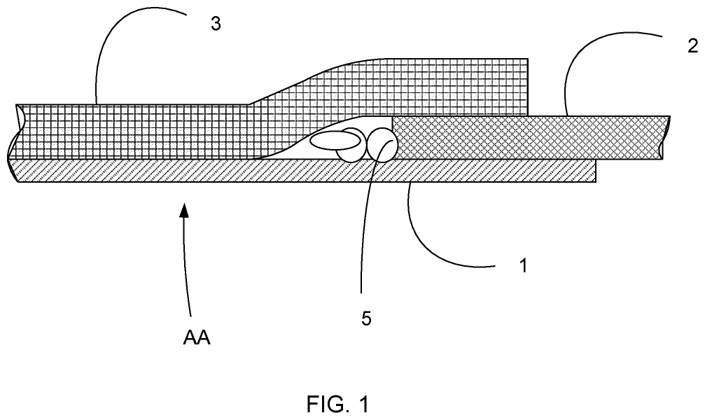

FIG. 2A and FIG. 2B are cross-sectional schematic diagrams of the bonding of the conventional polarizer plate and the touch panel causes a printed circuit board to be peeled off and the touch panel to be broken.

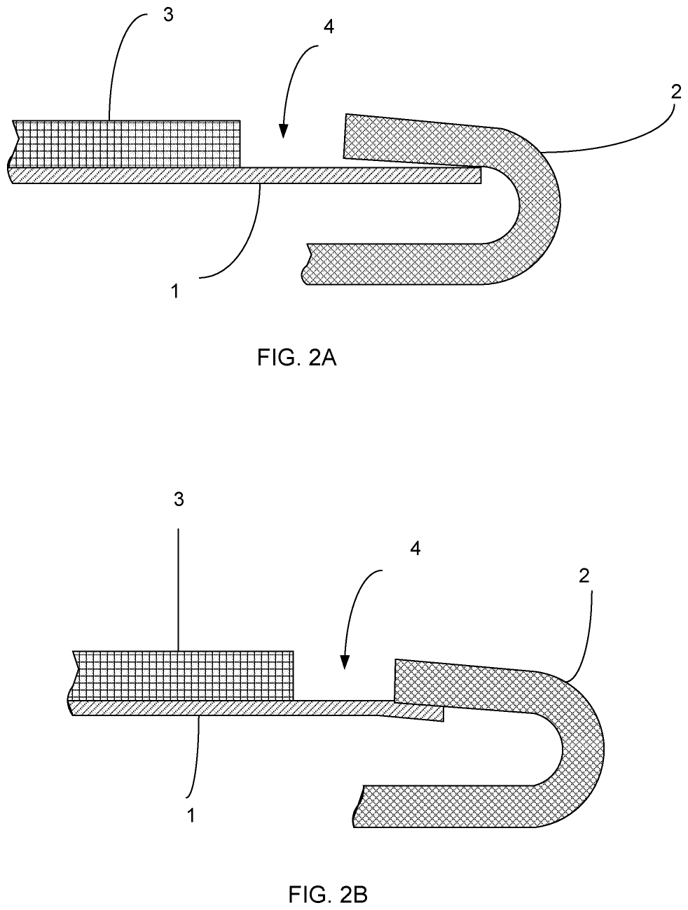

FIG. 3 is a cross-sectional schematic diagram of a touch display apparatus according to this disclosure.

FIG. 4 is a flowchart of a method for manufacturing the touch display apparatus according to the disclosure.

### DETAILED DESCRIPTION OF PREFERRED EMBODIMENTS

In order to more clearly describe the embodiments of the disclosure, the description is used to make a simple introduction of the drawings used in the following embodiments.

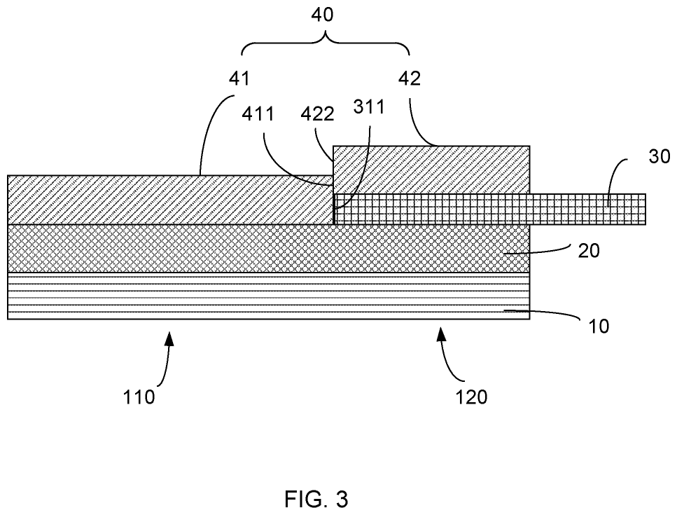

Referring to FIG. 3, a cross-sectional schematic diagram of a touch display apparatus according to this disclosure is shown. The disclosure provides a touch display apparatus. The touch display apparatus comprises a display panel 10 comprising a display area 110 and a non-display area 120, a touch panel 20 disposed on the display panel 10, a circuit board element 30 disposed on the touch panel 20 corresponding to the non-display area 120 of the display panel 10, and a polarizing element 40 comprising a first polarizing element 41 and a second polarizing element 42. The first polarizing element is disposed on the touch panel 20 corresponding to the display area 110 and a portion of the non-display area 120 of the display panel 10. Namely, the first polarizing element 41 extends from the display area 110 corresponding to the display panel 10 to the non-display area 120 of the portion of the display panel 10. The second polarizing element 42 is disposed on the circuit board element 30 corresponding to a remaining portion of the non-display area 120 (not covered by the first polarizing component 41) of the display panel 10. The first polarizing element 41 is closely adjacent to one side of the circuit board element 30. Namely, one side of the first polarizing element 41 is attached to one side of the circuit board element 30 and a part of a side of the second polarizing element 42. The second polarizing component 42 is closely attached to the circuit board element 30, so that there is no space/gap between the polarizing element 40, the touch panel 20, and the circuit board element 30.

Moreover, in this embodiment, the display panel 10 is a liquid crystal display (LCD) or an organic light-emitting diode (OLED) panel, but the disclosure is not limited thereto. The display panel 10 comprises the display area 110, which may also be referred to as an active area (AA). The active area is a range in which an image can be viewed by a user. In general, the display panel 10 comprises opposite left and right sides. In the following description, the cross-sectional structure close to the right side of the display panel 10 will be described, but in practical applications, the design of the disclosure is not limited to one side, and will be described in advance.

Specifically, a bonding area (not shown) is formed on the circuit board element 30 corresponding to the remaining portion of the non-display area 120. The bonding area of the circuit board element 30 corresponds to the remaining portion of the non-display area 120 (i.e., the area where a portion of the non-display area 120 corresponding to the first polarizing element 41 is subtracted). The remaining portion of the non-display area 120 provides the bonding area for the second polarizing element 42 being closely attached.

In order to avoid the formation of a gap between the polarizing element 40, the touch panel 20, and the circuit board assembly 30 and to avoid the formation of air bubbles in the gap which affect the performance and quality of the display area 110, the first polarizing element 41 is closely adjacent to the circuit board element 30 in a horizontal direction, the second polarizing element 42 is closely adjacent to the circuit board element 30 in a vertical direction. Thus, there is no gap between the polarizing element 40, the touch panel 20, and the circuit board element 30.

Specifically, the first polarizing element is disposed on the touch panel 20 corresponding to the display area 110 and a portion of the non-display area 120 of the display panel 10. Namely, the first polarizing element 41 extends from the display area 110 corresponding to the display panel 10 to the non-display area 120 of the portion of the display panel 10. The first polarizing element 41 comprises a first edge 411. The second polarizing element 42 comprises a second edge 422, and the circuit board element 30 comprises a third edge 311. The first edge 411 is aligned with the second edge 422 and the third edge 311. That is, the first edge 411 is attached to the third edge 311 in the horizontal direction, and the first edge 411 is further partially attached to the second edge 422 in the vertical direction.

Similarly, an interface between the first polarizing element 41 and the second polarizing element 42 is aligned with the third edge 311 of the circuit board element 30. That is, the interface where the first edge 411 is aligned with the second edge 422 is also aligned with the third edge 311 of the circuit board assembly 30.

In an embodiment of the disclosure, a length direction of the non-display area 120 and a length direction of the second polarizing component 42 are parallel to a length direction of the display panel 10, so that a drawback that any component will be too long when a frame of the display panel is installed subsequently is solved, which helps manufacture an ultra-narrow frame display.

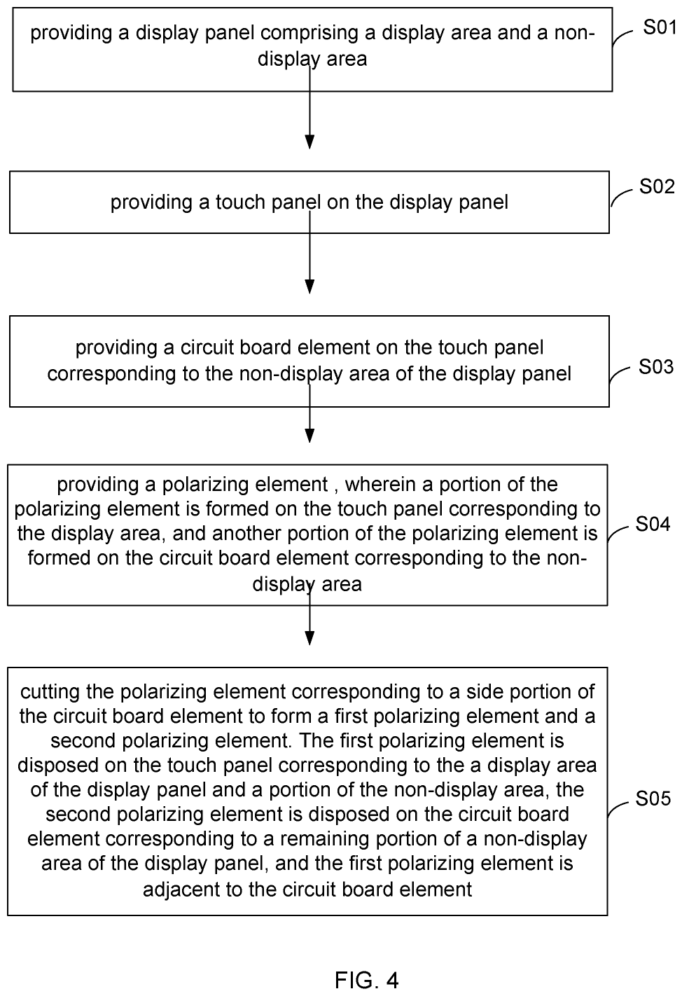

Referring to FIG. 4, a flowchart of a method for manufacturing the touch display apparatus according to the disclosure is shown. The method comprises the following steps.

In a step S01, a display panel is provided. The display panel comprises a display area and a non-display area.

In a step S02, a touch panel on the display panel is provided.

In a step S03, a circuit board element is provided. The circuit board element is disposed on an area of the touch panel corresponding to the non-display area of the display panel.

In a step S04, a polarizing element is provided. A portion of the polarizing element is formed on the touch panel corresponding to the display area, and another portion of the polarizing element is formed on the circuit board element corresponding to the non-display area.

In a step S05, cutting the polarizing element is cut for forming a first polarizing element and a second polarizing element corresponding to a side portion (i.e., a side of the touch panel) of the circuit board element. The first polarizing element is disposed on the touch panel corresponding to the display area of the display panel and a portion of the non-display area, and the second polarizing element is disposed on the circuit board element corresponding to a remaining portion of a non-display area of the display panel. The first polarizing element is adjacent to the circuit board element.

In order to avoid the formation of a gap between the polarizing element 40, the touch panel 20, and the circuit board assembly 30 and to avoid the formation of air bubbles in the gap which affect the performance and quality of the display area 110, the first polarizing element 41 is closely adjacent to the circuit board element 30 in a horizontal direction. Namely, one side of the first polarizing element 41 is attached to one side of the circuit board element 30 and a part of a side of the second polarizing element 42. Also, the second polarizing element 42 is closely adjacent to the circuit board element 30 in a vertical direction. Thus, there is no gap between the polarizing element 40, the touch panel 20, and the circuit board element 30.

Specifically, the first polarizing element is disposed on the touch panel 20 corresponding to the display area 110 and a portion of the non-display area 120 of the display panel 10. Namely, the first polarizing element 41 extends from the display area 110 corresponding to the display panel 10 to the non-display area 120 of the portion of the display panel 10. The first polarizing element 41 comprises a first edge 411. The second polarizing element 42 comprises a second edge 422, and the circuit board element 30 comprises a third edge 311. The first edge 411 is aligned with the second edge 422 and the third edge 311. That is, the first edge 411 is attached to the third edge 311 in the horizontal direction, and the first edge 411 is further partially attached to the second edge 422 in the vertical direction.

Similarly, an interface between the first polarizing element 41 and the second polarizing element 42 is aligned with the third edge 311 of the circuit board element 30. That is, the interface where the first edge 411 is aligned with the second edge 422 is also aligned with the third edge 311 of the circuit board assembly 30.

In an embodiment of the disclosure, a length direction of the non-display area 120 and a length direction of the second polarizing component 42 are parallel to a length direction of the display panel 10, so that a drawback that any component will be too long when a frame of the display panel is installed subsequently is solved, which helps to manufacture an ultra-narrow frame display.

The disclosure provides a touch display apparatus and a method for manufacturing the touch display apparatus. A polarizing plate is divided into two parts. One portion of the polarizing plate is attached on the touch panel corresponding to the display area of the display panel and a portion of the non-display area of the touch panel, the other portion of the polarizing plate is attached on the bonding area of the printed circuit board (i.e., a printed circuit board bonding area corresponding to a remaining portion of the non-display area on the display panel). One portion of the polarizing plate closely adhered to the touch panel in a horizontal direction and adjacent to the printed circuit board is configured to prevent a gap between the polarizing plate and the printed circuit board when the polarizing plate is bonded to the printed circuit board. The gap may cause bubbles in the gap and cause bubbles to enter into the display area. Moreover, the other portion of the polarizing plate adhered to the printed circuit board in a horizontal direction can enhance the structural strength between the printed circuit board and the touch panel. Thus, the drawbacks of the printed circuit board from being peeled off from the touch panel or the touch panel being broken caused by the bending of the printed circuit board can be prevented, thereby implementing the ultra-narrow frame display design of the touch display device.

This disclosure has been described with preferred embodiments thereof, and it is understood that many changes and modifications to the described embodiment can be carried out without departing from the scope and the spirit of the invention that is intended to be limited only by the appended claims.

What is claimed is:

1. A touch display apparatus, comprising:
a display panel comprising a display area and a non-display area;
a touch panel disposed on the display panel;
a circuit board element disposed on the touch panel corresponding to the non-display area of the display panel;
a polarizing element comprising a first polarizing element and a second polarizing element, wherein the first polarizing element is disposed on the touch panel corresponding to the display area and a portion of the non-display area of the display panel, the second polarizing element is disposed on the circuit board element corresponding to a remaining portion of the non-display area of the display panel, the first polarizing element is adjacent to the circuit board element, and the polarizing element is without clearance between the touch panel and the board element; and
wherein the first polarizing element is closely adjacent to the circuit board element in a horizontal direction, and the second polarizing element is closely attached to the circuit board element in a vertical direction.

2. The touch display apparatus according to claim 1, wherein the first polarizing element comprises a first edge, the second polarizing element comprises a second edge, the circuit board element comprises a third edge, and the first edge is aligned with the second edge and the third edge.

3. The touch display apparatus according to claim 2, wherein an interface between the first polarizing element and the second polarizing element is aligned with the third edge of the circuit board element.

4. The touch display apparatus according to claim 1, wherein a side portion of the first polarizing element is attached to a side portion of the circuit board element and a partial of a side portion of the second polarizing element.

5. The touch display apparatus according to claim 1, wherein a length direction of the non-display area and a length direction of the second polarizing element are parallel to a length direction of the display panel.

6. A touch display apparatus, comprising:
a display panel comprising a display area and a non-display area;
a touch panel disposed on the display panel;
a circuit board element disposed on the touch panel corresponding to the non-display area of the display panel;
a polarizing element comprising a first polarizing element and a second polarizing element, wherein the first polarizing element is disposed on the touch panel corresponding to the display area and a portion of the non-display area of the display panel, the second polarizing element is disposed on the circuit board element corresponding to a remaining portion of the non-display area of the display panel, the first polarizing element is adjacent to the circuit board element, and the polarizing element is without clearance between the touch panel and the board element.

7. The touch display apparatus according to claim 6, wherein the first polarizing element comprises a first edge, the second polarizing element comprises a second edge, the circuit board element comprises a third edge, and the first edge is aligned with the second edge and the third edge.

8. The touch display apparatus according to claim 7, wherein an interface between the first polarizing element and the second polarizing element is aligned with the third edge of the circuit board element.

9. The touch display apparatus according to claim 6, wherein a side portion of the first polarizing element is attached to a side portion of the circuit board element and a partial of a side portion of the second polarizing element.

10. The touch display apparatus according to claim 6, wherein a length direction of the non-display area and a length direction of the second polarizing element are parallel to a length direction of the display panel.

11. A method of manufacturing a touch display apparatus, comprising:
providing a display panel, wherein the display panel comprises a display area and a non-display area;
providing a touch panel on the display panel;
providing a circuit board element on the touch panel corresponding to the non-display area of the display panel;
providing a polarizing element, wherein a portion of the polarizing element is formed on the touch panel corresponding to the display area, and another portion of the polarizing element is formed on the circuit board element corresponding to the non-display area; and
cutting the polarizing element corresponding to a side portion of the circuit board element to form a first polarizing element and a second polarizing element, wherein the first polarizing element is disposed on the touch panel corresponding to the display area of the display panel and a portion of the non-display area, the second polarizing element is disposed on the circuit board element corresponding to a remaining portion of the non-display area of the display panel, and the first polarizing element is adjacent to the circuit board element.

12. The method according to claim 11, wherein the first polarizing element comprises a first edge, the second polarizing element comprises a second edge, the circuit board element comprises a third edge, and the first edge is aligned with the second edge and the third edge.

13. The method according to claim 12, wherein an interface between the first polarizing element and the second polarizing element is aligned with the third edge of the circuit board element.

14. The method according to claim 11, wherein a side portion of the first polarizing element is attached to a side portion of the circuit board element and a partial of a side portion of the second polarizing element.

15. The method according to claim 11, wherein a length direction of the non-display area and a length direction of the second polarizing element are parallel to a length direction of the display panel.
